(19) United States
(12) Patent Application Publication
(10) Pub. No.: US 2026/0273504 A1
(43) Pub. Date: Sep. 17, 2026

(54) MONTMORILLONITE DESICCANT AND PREPARATION METHOD THEREOF

(71) Applicant: Foshan Shunde Topcod Industry Co., Ltd., Foshan (CN)

(72) Inventors: Xiaoliang LIAO, Foshan (CN); Fu ZHONG, Foshan (CN); Sheng ZHONG, Foshan (CN)

(21) Appl. No.: 19/075,860

(22) Filed: Mar. 11, 2025

(51) Int. Cl. B01J 20/12; B01J 20/30; C01B 33/40

(52) U.S. Cl. CPC B01J 20/12; B01J 20/3021; B01J 20/3078; B01J 20/3085; C01B 33/40

(57) ABSTRACT

The present application discloses a montmorillonite desiccant and a preparation method thereof, falling within the field of desiccants. A montmorillonite desiccant is prepared by calcining bentonite and modified calcium hydroxide particles. A mass ratio of the modified calcium hydroxide particles to the bentonite is (20-50): (12.5-40); the calcium hydroxide is sequentially modified into a first pre-treated calcium hydroxide, a second pre-treated calcium hydroxide, and modified calcium hydroxide particles. Raw materials for preparing the first pre-treated calcium hydroxide include calcium hydroxide, an acid anhydride, and hexaalkyl cyclotrisiloxane. Raw materials for preparing the second pre-treated calcium hydroxide include the first pre-treated calcium hydroxide, a catalyst, and isophthalic acid. Raw materials for preparing the modified calcium hydroxide particles include the second pre-treated calcium hydroxide and a silicate. The present application has the effect of improving the moisture absorption rate of the montmorillonite desiccant.

### TECHNICAL FIELD

The present application relates to the field of desiccants, and more particularly, to a montmorillonite desiccant and a preparation method thereof.

### BACKGROUND ART

Desiccant is a substance that maintains relative dryness within a certain space and is currently widely used in various fields such as food, pharmaceutical, industrial, transportation, and even household use. There are many kinds of desiccants on the market, which can be divided into two categories based on the principle of moisture absorption: physical moisture absorption type, and chemical moisture absorption type.

The representative products of the physical moisture absorption type include silica gel desiccant, mineral desiccant, molecular sieve desiccant, and fiber desiccant. The representative products of the chemical moisture absorption type include calcium chloride desiccant, magnesium chloride desiccant, and calcium oxide desiccant. Physical moisture absorption desiccant has a low moisture absorption rate, but there is no obvious change after moisture absorption, thus the physical moisture absorption desiccant is mainly used in the packaging of small spaces such as food, medicine, and electronic products. Montmorillonite desiccant is also a kind of physical moisture absorption desiccant. Montmorillonite is a naturally mined ore with good environmental protection properties, and the state after moisture absorption is still dry. In response to plastic restrictions in countries such as Europe and America, montmorillonite is packaged in kraft paper, which can achieve a completely plastic-free effect and is widely used.

However, the montmorillonite desiccant has a low moisture absorption rate, with an average adsorption rate of only about 18%, so the montmorillonite desiccant is limited to be used in many industries.

### SUMMARY

In order to improve the moisture absorption rate of the montmorillonite desiccant, the present application provides a montmorillonite desiccant and a preparation method thereof.

In a first aspect, the montmorillonite desiccant provided in the present application adopts the following technical solution.

A montmorillonite desiccant prepared by calcining bentonite and modified calcium hydroxide particles, wherein a mass ratio of the modified calcium hydroxide particles to the bentonite is (20-50): (12.5-40);
the modified calcium hydroxide particles are prepared by the following steps: firstly, preparing a first pre-treated calcium hydroxide using calcium hydroxide, then preparing a second pre-treated calcium hydroxide using the first pre-treated calcium hydroxide, and finally preparing the modified calcium hydroxide particles using the second pre-treated calcium hydroxide;
raw materials for preparing the first pre-treated calcium hydroxide include calcium hydroxide, an acid anhydride, and hexaalkyl cyclotrisiloxane, and a mass ratio of the calcium hydroxide, the acid anhydride, and the hexaalkyl cyclotrisiloxane is (1.5-2.5): (3.5-4.5): (1.5-2.5);
raw materials for preparing the second pre-treated calcium hydroxide include the first pre-treated calcium hydroxide, a catalyst, and isophthalic acid, and a mass ratio of the first pre-treated calcium hydroxide, the catalyst, and the isophthalic acid is (1-2):(1-2): (4-5); and
raw materials for preparing the modified calcium hydroxide particles include the second pre-treated calcium hydroxide and a silicate, and a mass ratio of the second pre-treated calcium hydroxide to the silicate is (3-5): (1-2).

In the present application, by means of calcining the mixture of modified calcium hydroxide particles and bentonite, the modified calcium hydroxide particles are decomposed into calcium oxide particles and water after calcination; the calcium oxide particles in a montmorillonite structure can not only increase an interlayer spacing of the montmorillonite and improve a structure inside the montmorillonite but also can react with water to form a combination of chemical moisture absorption and physical moisture absorption, thereby improving the moisture absorption rate of the montmorillonite desiccant. In addition, the modified calcium hydroxide particles modified by multiple pretreatments have an oversized specific surface area, and the water decomposed after calcination is dried to form channels penetrating the inside of calcium oxide particles, so as to enhance the moisture absorption rate and moisture absorption capacity of water, so that the moisture absorption rate of the montmorillonite desiccant can reach more than 30%.

In some embodiments, the acid anhydride is one or more selected from a group consisting of: maleic anhydride, succinic anhydride, and glutaric anhydride.

In some embodiments, the hexaalkyl cyclotrisiloxane is one or two selected from a group consisting of: hexamethyl cyclotrisiloxane and hexaethyl cyclotrisiloxane.

In the present application, a coupling reaction between hexaalkyl cyclotrisiloxane and calcium hydroxide takes place using the acid anhydride as an auxiliary agent, and calcium hydroxide particles are modified by utilizing a crosslinking effect of a liquid phase oxidation of isophthalic acid, so as to further improve the specific surface area of the calcium hydroxide particles and form micro-spaces at the same time, so as to obtain the first pre-treated calcium hydroxide particles that have been subjected to preliminary modification treatment.

In some embodiments, the catalyst is yttrium nitrate.

In the present application, the isophthalic acid is catalytically oxidized under an action of yttrium nitrate and reacts with the first pre-treated calcium hydroxide particles to form a framework material on the calcium hydroxide particles to obtain the second pre-treated calcium hydroxide.

In some embodiments, the silicate is one or more selected from a group consisting of:

tetramethyl silicate and tetraethyl silicate.

In the present application, the silicate is used to perform siliconizing on a surface of the second pre-treated calcium hydroxide so as to improve the stability of a permeation channel of calcinated calcium oxide particles.

In a second aspect, a method for preparing the montmorillonite desiccant provided in the present application adopts the following technical solution.

A method for preparing the montmorillonite desiccant including the following steps:
preparation of the first pre-treated calcium hydroxide: adding calcium hydroxide into a first solvent, then adding the acid anhydride and hexaalkyl cyclotrisiloxane to obtain a reaction system, heating a temperature of the reaction system to 70-80° C. for a reaction, and after the reaction is finished, separating to obtain the first pre-treated calcium hydroxide;
preparation of the second pre-treated calcium hydroxide: adding the catalyst and isophthalic acid into a second solvent, stirring uniformly, gradually heating a temperature of a resulting mixture to 230-250° C., continuously stirring throughout a whole process of the preparation; adding the first pre-treated calcium hydroxide after reacting for a certain time to obtain a reaction system, continuing the reaction, and after an end of the reaction, cooling a temperature of the reaction system to room temperature and separating to obtain the second pre-treated calcium hydroxide;
preparation of the modified calcium hydroxide particles: adding the second pre-treated calcium hydroxide into a third solvent, heating a temperature of a resulting mixture to 50-60° C., then dropwise adding the silicate dispersed by the third solvent, continuing reaction after an end of the dropwise addition, and separating to obtain the modified calcium hydroxide particles;
preparation of a bentonite slurry: grinding the bentonite into a bentonite powder, and then mixing the bentonite powder with water to obtain the bentonite slurry;
preparation of the montmorillonite desiccant: adding the modified calcium hydroxide particles into the bentonite slurry, stirring uniformly, filtering under pressure, drying, grinding, and calcining at 700-850° C. to obtain the montmorillonite desiccant.

In the present application, the modified calcium hydroxide particles are prepared step by step, and the structure of calcium hydroxide is modified step by step, which is helpful to form calcium oxide particles containing numerous permeation channels and micro-spaces after calcination and improve the moisture absorption capacity. In addition, the bentonite slurry is obtained by mixing the bentonite powder with water, which effectively improves a binding capacity of bentonite to the modified calcium hydroxide particles, so that the calcium oxide particles can be better incorporated into the montmorillonite structure after calcination, realizing the combination of chemical moisture absorption and physical moisture absorption.

Further, the method for preparing the montmorillonite desiccant including the following steps: preparation of the first pre-treated calcium hydroxide: adding calcium hydroxide into the first solvent, then adding the acid anhydride and hexaalkyl cyclotrisiloxane to obtain a reaction system, heating the temperature of the reaction system to 70-80° C. and reacting for 2.5-4 h, and after the reaction is finished, separating to obtain the first pre-treated calcium hydroxide;
preparation of the second pre-treated calcium hydroxide: adding the catalyst and isophthalic acid into a second solvent, stirring uniformly, gradually heating the temperature of a resulting mixture to 230-250° C., continuously stirring throughout the whole process of the preparation; adding the first pre-treated calcium hydroxide after reacting for 4-5 h to obtain a reaction system, continuing the reaction for 6-7 h, and after the end of the reaction, cooling the temperature of the reaction system to room temperature and separating to obtain the second pre-treated calcium hydroxide;
preparation of the modified calcium hydroxide particles: adding the second pre-treated calcium hydroxide into the third solvent, heating the temperature of a resulting mixture to 50-60° C., then dropwise adding the silicate dispersed by the third solvent, continuing the reaction for 1-2 h after the end of the dropwise addition, and separating to obtain the modified calcium hydroxide particles;
preparation of the bentonite slurry: grinding the bentonite into a bentonite powder, and then mixing the bentonite powder with water to obtain the bentonite slurry;
a mass ratio of bentonite to water is 1:(1-3); and
preparation of the montmorillonite desiccant: adding the modified calcium hydroxide particles into the bentonite slurry, stirring uniformly, filtering under pressure, drying, grinding, and calcining for 3.5-4.5 h at 700-850° C. to obtain the montmorillonite desiccant.

In some embodiments, the first solvent includes acetonitrile.

In some embodiments, the second solvent includes ethyl acetate and water.

In some embodiments, the third solvent includes anhydrous methanol.

In some embodiments, in a step of preparation of the second pre-treated calcium hydroxide, the reaction is carried out in a pressure vessel, and a rate of the gradually heating is 3-5° C./min.

In the present application, conditions for the catalytic oxidation of isophthalic acid are high temperature and high pressure, and therefore it is necessary to control the heating rate within a suitable range so as not to excessively violate the reaction.

In some embodiments, in a step of preparation of the third pre-treated calcium hydroxide, a progress of the dropwise addition is controlled within 3-4 hours.

In the present application, the dropwise addition is controlled in a relatively slow process to achieve slow siliconizing of the second pre-treated calcium hydroxide.

In some embodiments, the calcium hydroxide has a particle size of less than or equal to 12000 mesh.

In the present application, controlling the particle size of the calcium hydroxide to be less than or equal to 12000 mesh facilitates the combination of calcium hydroxide with bentonite.

In some embodiments, in a step of preparation of the bentonite slurry, after the bentonite is ground into the bentonite powder, the bentonite powder is first subjected to magnetic field treatment to remove iron-containing impurities before mixing with water.

In the present application, iron-containing impurities are removed to ensure that no iron is contained in the montmorillonite desiccant, which meets requirements for use of the desiccant.

In summary, the present application has the following beneficial effects.

1. In the present application, by means of calcining the mixture of the modified calcium hydroxide particles and bentonite, the modified calcium hydroxide particles are decomposed into calcium oxide particles and water after calcination; the calcium oxide particles in the montmorillonite structure can not only increase the interlayer spacing of the montmorillonite and improve the structure inside the montmorillonite but also can react with water to form the combination of chemical moisture absorption and physical moisture absorption, thereby improving the moisture absorption rate of the montmorillonite desiccant. In addition, the modified calcium hydroxide particles modified by multiple pretreatments have an oversized specific surface area, and the water decomposed after calcination is dried to form channels penetrating the inside of calcium oxide particles, so as to enhance the moisture absorption rate and moisture absorption capacity of the water, so that the moisture absorption rate of the montmorillonite desiccant can reach more than 30%.

2. The modified calcium hydroxide particles are modified by siloxane coupling reaction, isophthalic acid crosslinking, and surface siliconizing, playing an important role in increasing the specific surface area of calcium hydroxide particles and forming micro-space, so that the calcinated calcium oxide particles are formed with permeation channel, improving the moisture absorption rate of the montmorillonite desiccant.

### DETAILED DESCRIPTION

The present application will be further described below in detail.

### Example 1

A method for preparing the montmorillonite desiccant included the following steps.

Preparation of first pre-treated calcium hydroxide: calcium hydroxide was added into acetonitrile, then the maleic anhydride and hexamethyl cyclotrisiloxane were added to obtain a reaction system. The temperature of the reaction system was heated to 70° C., and reacted for 4 h. After the reaction was finished, a product was separated by centrifuge, then washed and dried to obtain the first pre-treated calcium hydroxide;

The mass ratio of calcium hydroxide, maleic anhydride, and hexamethyl cyclotrisiloxane was 1.5:3.5:1.5, and the particle size of calcium hydroxide was selected to be capable of sieving a 12000 mesh.

Preparation of second pre-treated calcium hydroxide: yttrium nitrate, isophthalic acid, and ethyl acetate were successively added into distilled water, stirred uniformly at room temperature, and transferred into a high-pressure closed reaction kettle capable of withstanding a 3 MPa pressure. The temperature was heated to 230° C. at a rate of 3° C./min. Continuously stirring was carried out throughout the whole process of the preparation. After reacting for 4 h at this temperature, the first pre-treated calcium hydroxide was added to obtain a reaction system and continued to be stirred for 7 h. After the reaction was finished, the reaction system was cooled to room temperature, a product was filtered, separated, washed, and dried to obtain the second pre-treated calcium hydroxide.

The mass ratio of the first pre-treated calcium hydroxide, yttrium nitrate, isophthalic acid, ethyl acetate, and water was 1:1: 4:15: 30.

Preparation of modified calcium hydroxide particles: the second pre-treated calcium hydroxide was added into anhydrous methanol. The temperature was heated to 50° C. Then, anhydrous methanol solution containing tetramethyl silicate was slowly added dropwise. The progress of the dropwise addition was controlled at 4 h. The reaction was continued for 2 h after the end of the dropwise addition. A product was separated to obtain the modified calcium hydroxide particles.

The mass ratio of the second pre-treated calcium hydroxide to tetramethyl silicate was 3:1, and the content of tetramethyl silicate in the anhydrous methanol solution was 10 wt %. Therefore, the mass ratio of the second pre-treated calcium hydroxide, the anhydrous methanol solution, and the anhydrous methanol was 3:10: 50.

Preparation of the bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry.

The mass ratio of the bentonite to water was 1:3.

Preparation of montmorillonite desiccant: the modified calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the modified calcium hydroxide particles to bentonite slurry was 20:50.

### Example 2

A method for preparing the montmorillonite desiccant included the following steps.

Preparation of first pre-treated calcium hydroxide: calcium hydroxide was added into acetonitrile, then the maleic anhydride and hexamethyl cyclotrisiloxane were added to obtain a reaction system. The temperature of the reaction system was heated to 80° C., and reacted for 2.5 h. After the reaction was finished, a product was separated by centrifuge, then washed and dried to obtain the first pre-treated calcium hydroxide;

The mass ratio of calcium hydroxide, maleic anhydride, and hexamethyl cyclotrisiloxane was 2.5:4.5:2.5, and the particle size of calcium hydroxide was selected to be capable of sieving a 12000 mesh.

Preparation of second pre-treated calcium hydroxide: yttrium nitrate, isophthalic acid, and ethyl acetate were successively added into distilled water, stirred uniformly at room temperature, and transferred into a high-pressure closed reaction kettle capable of withstanding a 3 MPa pressure. The temperature was heated to 250° C. at a rate of 5° C./min. Continuously stirring was carried out throughout the whole process of the preparation. After reacting for 5 h at this temperature, the first pre-treated calcium hydroxide was added to obtain a reaction system and continued to be stirred for 6 h. After the reaction was finished, the reaction system was cooled to room temperature, a product was filtered, separated, washed, and dried to obtain the second pre-treated calcium hydroxide.

The mass ratio of the first pre-treated calcium hydroxide, yttrium nitrate, isophthalic acid, ethyl acetate and water was 2:2:5:20:40.

Preparation of modified calcium hydroxide particles: the second pre-treated calcium hydroxide was added into anhydrous methanol. The temperature was heated to 60° C. Then, anhydrous methanol solution containing tetramethyl silicate was slowly added dropwise. The progress of the dropwise addition was controlled at 3 h. The reaction was continued for 1 h after the end of the dropwise addition. A product was separated to obtain the modified calcium hydroxide particles.

The mass ratio of the second pre-treated calcium hydroxide to tetramethyl silicate was 5:2, and the content of tetramethyl silicate in the anhydrous methanol solution was 10 wt %. Therefore, the mass ratio of the second pre-treated calcium hydroxide, the anhydrous methanol solution and the anhydrous methanol was 5:20:50.

Preparation of the bentonite slurry: the bentonite was ground into a bentonite powder, a bentonite powder was subjected to magnetic field treatment to remove iron-containing impurities, then passed through a 200-mesh sieve, and then mixed with water to obtain the bentonite slurry.

The mass ratio of the bentonite to water was 1:1.

Preparation of montmorillonite desiccant: the modified calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 850° C. for 3.5 h to obtain the montmorillonite desiccant.

The mass ratio of the modified calcium hydroxide particles to bentonite slurry was 50:80.

### Example 3

A method for preparing the montmorillonite desiccant included the following steps.

Preparation of first pre-treated calcium hydroxide: calcium hydroxide was added into acetonitrile, then the maleic anhydride and hexamethyl cyclotrisiloxane were added to obtain a reaction system. The temperature of the reaction system was heated to 70° C., and reacted for 4 h. After the reaction was finished, a product was separated by centrifuge, then washed and dried to obtain the first pre-treated calcium hydroxide.

The mass ratio of calcium hydroxide, maleic anhydride, and hexamethyl cyclotrisiloxane was 2:4: 2, and the particle size of calcium hydroxide was selected to be capable of sieving a 12000 mesh.

Preparation of second pre-treated calcium hydroxide: yttrium nitrate, isophthalic acid, and ethyl acetate were successively added into distilled water, stirred uniformly at room temperature, and transferred into a high-pressure closed reaction kettle capable of withstanding a 3 MPa pressure. The temperature was heated to 230° C. at a rate of 3° C./min. Continuously stirring was carried out throughout the whole process of the preparation. After reacting for 4 h at this temperature, the first pre-treated calcium hydroxide was added to obtain a reaction system and continued to be stirred for 7 h. After the reaction was finished, the reaction system was cooled to room temperature, a product was filtered, separated, washed, and dried to obtain the second pre-treated calcium hydroxide.

The mass ratio of the first pre-treated calcium hydroxide, yttrium nitrate, isophthalic acid, ethyl acetate and water was 1.5:1.5:4.5:18:38.

Preparation of modified calcium hydroxide particles: the second pre-treated calcium hydroxide was added into anhydrous methanol. The temperature was heated to 50° C. Then, anhydrous methanol solution containing tetramethyl silicate was slowly added dropwise. The progress of the dropwise addition was controlled at 4 h. The reaction was continued for 2 h after the end of the dropwise addition. A product was separated to obtain the modified calcium hydroxide particles.

The mass ratio of the second pre-treated calcium hydroxide to tetramethyl silicate was 4:1.5, and the content of tetramethyl silicate in the anhydrous methanol solution was 10 wt %. Therefore, the mass ratio of the second pre-treated calcium hydroxide, the anhydrous methanol solution and the anhydrous methanol was 4:15:50.

Preparation of the bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry.

The mass ratio of the bentonite to water was 1:1.

Preparation of montmorillonite desiccant: the modified calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the modified calcium hydroxide particles to bentonite slurry was 30:60.

### Comparative Example 1

A method for preparing the montmorillonite desiccant included the following steps.

Preparation of bentonite slurry: the bentonite was ground into a bentonite powder, the bentonite powder was subjected to magnetic field treatment to remove iron-containing impurities, then mixed with water to obtain the bentonite slurry.

The mass ratio of the bentonite to water was 1:1.

Preparation of the montmorillonite desiccant: the bentonite slurry was added into a filter press, subjected to filter pressing for 15 h, dried, and sieved a portion that passed through a 200-mesh sieve to obtain the montmorillonite desiccant.

### Comparative Example 2

A method for preparing the montmorillonite desiccant included the following steps.

Preparation of bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry.

The mass ratio of the bentonite to water was 1:1.

Preparation of montmorillonite desiccant: calcium hydroxide with a particle size capable of sieving a 12000 meshes was selected to be added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the calcium hydroxide to bentonite was 30:60.

### Comparative Example 3

A method for preparing the montmorillonite desiccant included the following steps.

Preparation of second pre-treated calcium hydroxide: yttrium nitrate, isophthalic acid, and ethyl acetate were successively added into distilled water, stirred uniformly at room temperature, and transferred into a high-pressure closed reaction kettle capable of withstanding a 3 MPa pressure. The temperature was heated to 230° C. at a rate of 3° C./min. Continuously stirring was carried out throughout the whole process of the preparation. After reacting for 4 h at this temperature, calcium hydroxide with a particle size capable of sieving a 12000 meshes was selected to be added to obtain a reaction system and continued to be stirred for 7 h. After the reaction was finished, the reaction system was cooled to room temperature, a product was filtered, separated, washed, and dried to obtain the second pre-treated calcium hydroxide.

The mass ratio of the calcium hydroxide, yttrium nitrate, isophthalic acid, ethyl acetate and water was 1.5:1.5:4.5:18:38.

Preparation of modified calcium hydroxide particles: the second pre-treated calcium hydroxide was added into anhydrous methanol. The temperature was heated to 50° C. Then, anhydrous methanol solution containing tetramethyl silicate was slowly added dropwise. The progress of the dropwise addition was controlled at 4 h. The reaction was continued for 2 h after the end of the dropwise addition. A product was separated to obtain the modified calcium hydroxide particles.

The mass ratio of the second pre-treated calcium hydroxide to tetramethyl silicate was 4:1.5, and the content of tetramethyl silicate in the anhydrous methanol solution was 10 wt %. Therefore, the mass ratio of the second pre-treated calcium hydroxide, the anhydrous methanol solution and the anhydrous methanol was 4:15:50.

Preparation of bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry. The mass ratio of the bentonite to water was 1:1.

Preparation of montmorillonite desiccant: the modified calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the modified calcium hydroxide particles to bentonite slurry was 30:60.

### Comparative Example 4

A method for preparing the montmorillonite desiccant included the following steps.

Preparation of first pre-treated calcium hydroxide: calcium hydroxide was added into acetonitrile, then the maleic anhydride and hexamethyl cyclotrisiloxane were added to obtain a reaction system. Te temperature of the reaction system was heated to 70° C., and reacted for 4 h. After the reaction was finished, a product was separated by centrifuge, then washed and dried to obtain the first pre-treated calcium hydroxide.

The mass ratio of calcium hydroxide, maleic anhydride, and hexamethyl cyclotrisiloxane was 2:4: 2, and the particle size of calcium hydroxide was selected to be capable of sieving a 12000 mesh.

Preparation of modified calcium hydroxide particles: the first pre-treated calcium hydroxide was added into anhydrous methanol. The temperature was heated to 50° C. Then, anhydrous methanol solution containing tetramethyl silicate was slowly added dropwise. The progress of the dropwise addition was controlled at 4 h. The reaction was continued for 2 h after the end of the dropwise addition. A product was separated to obtain the modified calcium hydroxide particles.

The mass ratio of the first pre-treated calcium hydroxide to tetramethyl silicate was 4:1.5, and the content of tetramethyl silicate in the anhydrous methanol solution was 10 wt %. Therefore, the mass ratio of the first pre-treated calcium hydroxide, the anhydrous methanol solution and the anhydrous methanol was 4:15:50.

Preparation of bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry.

The mass ratio of the bentonite to water was 1:1.

Preparation of montmorillonite desiccant: the modified calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the modified calcium hydroxide particles to bentonite slurry was 30:60.

### Comparative Example 5

A method for preparing the montmorillonite desiccant included the following steps.

Preparation of first pre-treated calcium hydroxide: calcium hydroxide was added into acetonitrile, then the maleic anhydride and hexamethyl cyclotrisiloxane were added to obtain a reaction system. The temperature of the reaction system was heated to 70° C., and reacted for 4 h. After the reaction was finished, a product was separated by centrifuge, then washed and dried to obtain the first pre-treated calcium hydroxide;
The mass ratio of the calcium hydroxide, maleic anhydride, and hexamethyl cyclotrisiloxane was 2:4: 2, and the particle size of calcium hydroxide was selected to be capable of sieving a 12000 mesh.

Preparation of second pre-treated calcium hydroxide: yttrium nitrate, isophthalic acid, and ethyl acetate were successively added into distilled water, stirred uniformly at room temperature, and transferred into a high-pressure closed reaction kettle capable of withstanding a 3 MPa pressure. The temperature was heated to 230° C. at a rate of 3° C./min. Continuously stirring was carried out throughout the whole process of the preparation. After reacting for 4 h at this temperature, the first pre-treated calcium hydroxide was added to obtain a reaction system and continued to be stirred for 7 h. After the reaction was finished, the reaction system was cooled to room temperature, a product was filtered, separated, washed, and dried to obtain the second pre-treated calcium hydroxide.

The mass ratio of the first pre-treated calcium hydroxide, yttrium nitrate, isophthalic acid, ethyl acetate and water was 1.5:1.5:4.5:18:38.

Preparation of the bentonite slurry: the bentonite was ground into a bentonite powder, the bentonite powder was subjected to magnetic field treatment to remove iron-containing impurities, then passed through a 200-mesh sieve, and then mixed with water to obtain the bentonite slurry.

The mass ratio of the bentonite to water was 1:1.

Preparation of montmorillonite desiccant: the second pre-treated calcium hydroxide particles were added into the bentonite slurry and stirred uniformly. A resulting mixture was packed by using a filter cloth, placed into a filter press for pressure filtration for 15 h, dried, and ground into broken particles. The broken particles were calcined at 700° C. for 4.5 h to obtain the montmorillonite desiccant.

The mass ratio of the second pre-treated calcium hydroxide to the bentonite slurry was 30:60.

### Performance Testing

Moisture absorption rate testing: referring to the moisture absorption rate testing method in BBT0049-2021 “Desiccant for packaging”. 10 g of solid agglomerated desiccants prepared in Examples 1-3 and Comparative Examples 1-5 were each placed in a constant temperature and humidity chamber. The moisture absorption rate on the third day after the start of the testing was calculated. After the desiccant reached adsorption equilibrium, the total moisture absorption rate was calculated. The temperature of the constant temperature and humidity chamber was 25° C.±2° C. and the relative humidity was 90%+2%. The test results are shown in Table 1.

TABLE 1

| | Total Moisture | Moisture absorption rate |
|---|---|---|
| | Absorption Rate (%) | in three days (%) |
| Example 1 | 30.6 | 18.6 |
| Example 2 | 31.0 | 17.5 |
| Example 3 | 31.5 | 18.3 |
| Comparative | 18.2 | 8.4 |
| Example 1 | | |
| Comparative | 21.3 | 11.5 |
| Example 2 | | |
| Comparative | 23.6 | 12.5 |
| Example 3 | | |
| Comparative | 23.1 | 12.8 |
| Example 4 | | |
| Comparative | 24.1 | 11.7 |
| Example 5 | | |

As can be seen from Table 1, the montmorillonite desiccant prepared in Example 3 had a higher total moisture absorption rate compared with the conventional montmorillonite desiccant prepared in Comparative Example 1; the total moisture absorption rate was improved by more than 60%; the moisture absorption rate in the first three days was also higher; the adsorption rate was higher, indicating that the calcination of the mixture of the modified calcium hydroxide particles and bentonite can effectively improve the internal structure of montmorillonite and form a combination of chemical and physical moisture absorption mode, broadening the application range of montmorillonite desiccant.

Compared with Comparative Example 2, the calcination of the mixture of calcium hydroxide and bentonite was not enough to improve the moisture absorption rate of montmorillonite desiccant, indicating that the calcinated calcium oxide particles have the characteristics of multi-permeation channels and micro-space, which is the key to improve the moisture absorption rate of montmorillonite desiccant.

Compared with the Comparative Examples 3-5, for the modified calcium hydroxide, it can be seen that the siloxane coupling reaction modification of calcium hydroxide, crosslinking with isophthalic acid, and the siliconizing on the surface of calcium hydroxide particles all have a significant effect on the subsequent preparation of montmorillonite desiccant, and improve the moisture absorption rate of the montmorillonite desiccant.

The specific embodiments are only an explanation of the present application and are not a limitation of the present application. Those skilled in the art may make noncreative modifications to the present specific embodiments as needed after reading this specification, but as long as it falls within the scope of the claims of the present application, it is protected by the patent law.

What is claimed is:

1. A montmorillonite desiccant prepared by calcining bentonite and modified calcium hydroxide particles, wherein a mass ratio of the modified calcium hydroxide particles to the bentonite is (20-50): (12.5-40);
the modified calcium hydroxide particles are prepared by the following steps: firstly, preparing a first pre-treated calcium hydroxide using calcium hydroxide, then preparing a second pre-treated calcium hydroxide using the first pre-treated calcium hydroxide, and finally preparing the modified calcium hydroxide particles using the second pre-treated calcium hydroxide;
raw materials for preparing the first pre-treated calcium hydroxide comprise the calcium hydroxide, an acid anhydride, and hexaalkyl cyclotrisiloxane, and a mass ratio of the calcium hydroxide, the acid anhydride, and the hexaalkyl cyclotrisiloxane is (1.5-2.5): (3.5-4.5): (1.5-2.5);
raw materials for preparing the second pre-treated calcium hydroxide comprise the first pre-treated calcium hydroxide, a catalyst, and isophthalic acid, and a mass ratio of the first pre-treated calcium hydroxide, the catalyst and the isophthalic acid is (1-2):(1-2): (4-5); and
raw materials for preparing the modified calcium hydroxide particles comprise the second pre-treated calcium hydroxide and a silicate, and a mass ratio of the second pre-treated calcium hydroxide to the silicate is (3-5): (1-2).

2. The montmorillonite desiccant according to claim 1, wherein the acid anhydride is one or more selected from a group consisting of: maleic anhydride, succinic anhydride, and glutaric anhydride.

3. The montmorillonite desiccant according to claim 1, wherein the hexaalkyl cyclotrisiloxane is one or two selected from a group consisting of: hexamethyl cyclotrisiloxane and hexaethyl cyclotrisiloxane.

4. The montmorillonite desiccant according to claim 1, wherein the catalyst is yttrium nitrate.

5. The montmorillonite desiccant according to claim 1, wherein the silicate is one or more selected from a group consisting of: tetramethyl silicate and tetraethyl silicate.

6. A method for preparing the montmorillonite desiccant according to claim 1, comprising the following steps:
preparing the first pre-treated calcium hydroxide by adding the calcium hydroxide into a first solvent, then adding the acid anhydride and the hexaalkyl cyclotrisiloxane to obtain a first reaction system, heating the first reaction system to 70-80° C. for a first reaction, and after the first reaction is finished, separating to obtain the first pre-treated calcium hydroxide;
preparing the second pre-treated calcium hydroxide by adding the catalyst and the isophthalic acid into a second solvent to obtain a first resulting mixture, stirring uniformly, gradually heating the first resulting mixture to 230-250° C., continuously stirring throughout a whole process of preparing the second pre-treated calcium hydroxide; adding the first pre-treated calcium hydroxide after reacting during a second reaction for a specified time to obtain a second reaction system, continuing the second reaction, and after an end of the second reaction, cooling the second reaction system to room temperature and separating to obtain the second pre-treated calcium hydroxide;
preparing the modified calcium hydroxide particles by adding the second pre-treated calcium hydroxide into a third solvent to obtain a second resulting mixing, heating the second resulting mixture to 50-60° C., then dropwise adding the silicate dispersed by the third solvent, continuing reaction after an end of the dropwise addition, and separating to obtain the modified calcium hydroxide particles;
preparing a bentonite slurry by grinding the bentonite into a bentonite powder, and then mixing the bentonite powder with water to obtain the bentonite slurry; and
preparing the montmorillonite desiccant by adding the modified calcium hydroxide particles into the bentonite slurry, stirring uniformly, filtering under pressure, drying, grinding, and calcining at 700-850° C. to obtain the montmorillonite desiccant.

7. The method for preparing the montmorillonite desiccant according to claim 6, wherein in the step of preparing the second pre-treated calcium hydroxide, the second reaction is carried out in a pressure vessel, and a rate of the gradually heating is 3-5° C./min.

8. The method for preparing the montmorillonite desiccant according to claim 6, wherein in the step of preparing the modified calcium hydroxide particles, a progress of the dropwise addition is controlled within 3-4 hours.

9. The method for preparing the montmorillonite desiccant according to claim 6, wherein a particle size of the calcium hydroxide is less than or equal to 12000 mesh.

10. The method for preparing the montmorillonite desiccant according to claim 6, wherein in the step of preparing the bentonite slurry, after the bentonite is ground into the bentonite powder, the bentonite powder is first subjected to magnetic field treatment to remove iron-containing impurities before mixing with the water.
